(19) United States
(12) Patent Application Publication
(10) Pub. No.: US 2022/0244936 A1
(43) Pub. Date: Aug. 4, 2022

(54) DYNAMICALLY EVOLVING AND UPDATING CONNECTOR MODULES IN AN INTEGRATION PLATFORM

(71) Applicant: salesforce.com, inc., San Francisco, CA (US)

(72) Inventor: Anton Kravchenko, San Francisco, CA (US)

(73) Assignee: salesforce.com, inc., San Francisco, CA (US)

(21) Appl. No.: 17/162,688

(22) Filed: Jan. 29, 2021

(51) Int. Cl. G06F 8/65; G06N 3/04; G06N 3/08; G06F 9/54

(52) U.S. Cl. CPC G06F 8/65; G06N 3/04; H04L 43/0876; G06F 9/541; G06N 3/08

(57) ABSTRACT

Disclosed herein are system, method, and computer program product embodiments for dynamically evolving and updating connector modules in an integration platform. A method includes collecting operation data regarding a plurality of operations implemented by each user in a plurality of users to build integrations in an integration platform, the plurality of operations being associated with building the integrations using one or more connector modules, identifying one or more patterns in the operation data by applying a pattern recognition algorithm to the operation data, the one or more patterns comprising data regarding at least one of top used operations in the integration platform, new API calls, new configurations, and modifications in source code associated with the one or more connector modules by the plurality of users, and updating the one or more connector modules in the integration platform based on the one or more patterns.

### BACKGROUND

Integration platforms allow organizations to design, implement, and deploy software tools that integrate and harness heterogeneous resources (e.g., applications, services, and data sources) from across the organization's technical landscape. An integration platform may build integration applications, retrieve and transform data, interact with various application programming interfaces (APIs), deploy integration applications to users, and otherwise maintain integration applications. In some cases, connector modules may be used in the integration platform to connect applications to external APIs, including transmitting and receiving messages over a protocol to and from an API, and processing these messages. Developers may need to customize the connectors so that they can interface with APIs effectively. However, conventional systems have only provided limited capability for customizing connectors, and customizing connectors may be time-consuming and necessitate frequent updates and maintenance by developers to stay current for user needs.

### BRIEF DESCRIPTION OF THE DRAWINGS/FIGURES

The accompanying drawings, which are incorporated herein and form a part of the specification, illustrate embodiments of the present disclosure and, together with the description, further serve to explain the principles of the disclosure and to enable a person skilled in the arts to make and use the embodiments.

FIG. 1 is a block diagram of an environment of an integration platform, according to some embodiments.

FIG. 2 is a block diagram illustrating a sequence of events for dynamically updating connector modules in an integration platform, according to some embodiments.

FIG. 3 is a block diagram of a connector module, according to some embodiments.

FIG. 4 illustrates a method for updating connector modules in an integration platform using pattern recognition, according to some embodiments.

FIG. 5 illustrates a computer system, according to exemplary embodiments of the present disclosure.

The present disclosure will be described with reference to the accompanying drawings. In the drawings, like reference numbers indicate identical or functionally similar elements. Additionally, the left-most digit of a reference number identifies the drawing in which the reference number first appears.

### DETAILED DESCRIPTION

Provided herein are system, apparatus, device, method and/or computer program product embodiments, and/or combinations and sub-combinations thereof, for dynamically evolving and updating connectors in an integration platform.

An organization's enterprise landscape may incorporate a wide-array of applications, services, data sources, servers, and other resources. Applications in the landscape may be varied and numerous and include: custom-built applications, legacy applications, database applications, cloud-based applications, and enterprise-resource-planning applications, just to name a few examples. These applications and their associated data may reside on different servers in different locations or data centers and/or be accessed via the cloud.

An integration platform may allow users to create useful business processes, applications, and other software tools that will be referred to herein as integration applications, integration scenarios, and/or integration flows. Integration flows may leverage data from the organization's disparate systems and applications. An integration platform may bridge divides between technical resources by centralizing communications. The integration platform may include message buses/protocols to facilitate communication between applications, data flow coordinators, connectors, security and data protection, dashboards and analysis tools, APIs, and other suitable tools.

Users may employ connectors to build integrations providing connection between integration flows in the integration platform and external resources, such as databases, APIs for software as a service (SaaS) applications, or the like. In some cases, there may be a growing number of specialized APIs, and the number of existing connectors available in the integration platform for connecting to each API may be limited. Thus, users (e.g., developers) may currently need to customize existing connectors or build their own connectors by writing code for various use case scenarios in the integration platform. In some cases, each connector may incorporate a large number of fields, and it may be difficult and time-consuming for users to manually code connector modules as needed.

Thus, in order to minimize the need for users coding their own connectors, disclosed herein are system, apparatus, device, method and/or computer program product embodiments for collecting operation data from users engaging in the integration platform, applying a pattern recognition algorithm to identify patterns in the operation data to assess which operations are being used the most, which APIs are being called, and what modifications are being made, and the like. The one or more connector modules may then be updated in the integration platform based on these one or more patterns identified in order to accelerate connector development in an efficient manner and provide users with faster access to updated connectors in the integration platform.

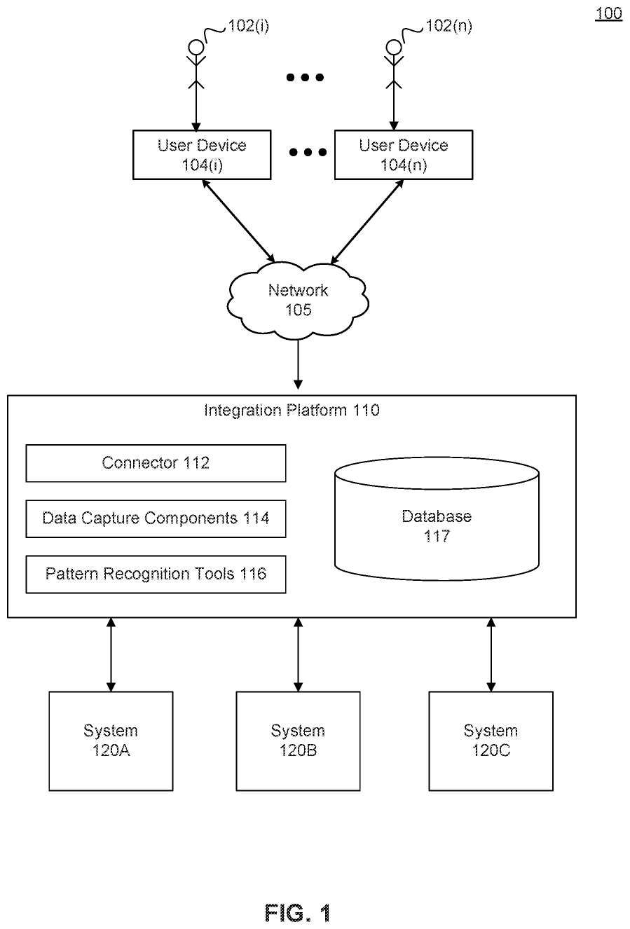

FIG. 1 is a block diagram of environment 100 of an integration platform, according to some embodiments. Any operation herein may be performed by any type of structure in the diagram, such as a module or dedicated device, in hardware, software, or any combination thereof. Any block in the block diagram of FIG. 1 may be regarded as a module, apparatus, dedicated device, general-purpose processor, engine, state machine, application, functional element, or related technology capable of and configured to perform its corresponding operation(s) described herein. Environment 100 may include users 102(i)-102(n), devices 104(i)-104(n), network 105, integration platform 110, and systems 120.

Users 102(i)-102(n) may represent a plurality of developers or other individuals designing, developing, and deploying integration flows using an integration platform 110. In some embodiments, users 102(i)-102(n) may be referred to herein as users 102. One or more users 102 may be members of a business, organization, and/or other suitable group. One or more users 102 may be human beings, but one or more users 102 may also be artificial intelligence constructs.

Devices 104(i)-104(n) may be associated with users 102(i)-102(n), in which each device 104 may correspond to and be operated by a user 102. In some embodiments, devices 104(i)-104(n) may be referred to herein as devices 104. Each device 104 may be a personal digital assistant, desktop workstation, laptop or notebook computer, netbook, tablet, smart phone, mobile phone, smart watch or other wearable, appliance, augmented reality (AR) device, virtual reality (VR) device, part of the Internet-of-Things, and/or embedded system, to name a few non-limiting examples, or any combination thereof. In some embodiments, each device 104 may include one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by integration platform 110. For example, the user interface device can be used to build integrations using integration platform 110, access data and applications hosted by systems 120, perform searches on stored data, and otherwise allow one or more of users 102 to interact with various GUI pages that may be presented to the one or more of users 102.

Devices 104 might communicate with integration platform 110 and/or systems 120 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more devices 104 might include an HTTP client, commonly referred to as a “browser,” for sending and receiving HTTP messages to and from server(s) of integration platform 110 and/or systems 120, thus allowing users 102 of the devices 104 to access, process and view information, pages and applications available to it from integration platform 110 and/or systems 120 over a network 105.

Users 102 may employ devices 104 to connect to network 105. Network 105 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between integration platform 110, systems 120, and/or devices 104.

Integration platform 110 may allow users 102 to build integrations and/or APIs, and design integration applications that access, manipulate, and otherwise use disparate technical resources. In some embodiments, integration platform 110 may allow users 102 to build integrations providing connections to third-party systems and data, and provide additional functionalities to further integrate data from a wide-array of organizational and on-the-cloud data sources. Integration platform 110 may include one or more user interface components to render a user interface for users 102 via devices 104. In some embodiments, integration platform 110 may provide a user interface that allows users 102 to select and design various connectors 112 and/or other components, such as APIs, templates, examples, and other components stored within database 117 in integration platform 110.

In some embodiments, integration platform 110 may include a JavaScript user interface library to control dynamic interactions between users 102 and integration platform 110 and/or a development toolkit facilitating the building of HTML5 or mobile applications. In some embodiments, integration platform 110 may allow a business or organization to upgrade components used by integration platform 110 in order to change the experience for users 102 over time.

Integration platform 110 may also include runtime components to build, assemble, compile, or otherwise create executable object code for specific integration scenarios to allow an integration application to function at runtime. In some embodiments, runtime components may create interpreted code to be parsed and applied upon execution. In some embodiments, runtime components may include a variety of intermediary hardware and/or software that runs and processes the output of integration flows. In some embodiments, integration platform 110 may connect to ancillary systems to retrieve, store, and manipulate data using an appropriate API or other method.

Integration platform 110 includes connector 112, data capture components 114, and pattern recognition tools 116. Connector 112 may represent a plurality of connectors 112 comprising pre-built assets that users 102 may leverage to connect to particular data sources or for using particular data protocols. In some embodiments, connector 112 may be referred to herein as a connector module. In some embodiments, users 102 might not find a specific connector 112 in integration platform 110 for a specific application, in which they are interested. Thus, users 102 may customize existing connectors 112 to access specific applications and/or build specific integration flows that necessitate writing code and transforming data within existing connectors 112. In some embodiments, users 102 may configure connectivity by inputting data for specific use-cases they are interested in by using the connectors 112 available in integration platform 110 to create an integration.

An example of an integration is provided below. This integration is merely exemplary, however, and one skilled in the relevant arts will appreciate that integrations may perform a vast and expansive array of functions that may differ between individuals and among organizations. Some integrations may incorporate dozens or even hundreds of assets into the integration scenario.

In one example of an integration, a user 102 may want to connect to a communication platform system through the integration platform 110. However, a pre-built connector 112 might not be available in the integration platform 100. Thus, the user 102 may configure an existing connector 112 (e.g., an HTTP connector) to directly call an API corresponding to the communication platform system through the integration platform 110. The user 102 may provide configuration information, including a base uniform resource locator (URL), operation information, parameters, authentication information, and the like. The user 102 may then test the connection and deploy the application to the integration platform 110.

In other use-case examples of integrations in the integration platform 110, other users 102 may call new APIs, add triggers to existing connectors 112, further customize existing connectors 112, and the like. In order to build each of the different integrations, each user 102 may need to configure a large number of fields and/or customize properties in the connector 112.

Accordingly, in order to capture the various customizations and designs of different connectors 112 by the plurality of users 102, the integration platform 110 may use data capture components 114 and pattern recognition tools 116 to collect operation data of users 102 in the integration environment and identify patterns in the operation data, respectively, for dynamically evolving and updating connectors 112 in the integration platform 110. Data capture components 114 may collect operation data regarding various operations and/or transactions implemented by users 102 in integration platform 100. In some embodiments, data capture components 114 may collect operation data while users 102 are creating integrations. In some embodiments, data capture components 114 may collect operation data by monitoring network traffic users engaging on the integration platform 110.

In some embodiments, data capture components 114 may collect operation data including operations, authentication options, and other configurations implemented by users 102 to enhance existing connectors 112. In some embodiments, operation data may represent data collected during usage of connectors 112 in integration platform 110 by users 102. In some embodiments, examples of operation data may include but are not limited to queryParameters, dataTypes, mediaTypes, schemes, and/or response and request bodies. In some embodiments, data capture components 114 may collect operation data including errors messages received by users 102 while working with different connectors 112 in integration platform 110. In some embodiments, data capture components 114 may collect operation data during integration design by users 102 in integration platform 110 and/or during runtime when designed integrations are deployed in integration platform 110.

Pattern recognition tools 116 may receive operation data from data capture components 114 and identify one or more patterns in the operation data by applying a pattern recognition algorithm to the operation data. In some embodiments, pattern recognition tools 116 may be referred to herein as a pattern recognition module comprising a pattern recognition algorithm. In some embodiments, pattern recognition tools 116 may train a pattern recognition algorithm, such as a neural network or classifier, to recognize patterns and predict updates for one or more connectors 112.

In some embodiments, pattern recognition tools 116 may receive, from data capture components 114, operation data including errors messages received by users 102 utilizing various connectors 112. Pattern recognition tools 116 may identify which error messages are received most frequently by users 102 using a classifier or neural network. Based on this identification, Pattern recognition tools 116 may determine what updates are needed for the various connectors 112 and generate real-time fixes for the connectors 112 to resolve the error messages. In some embodiments, pattern recognition tools 116 may recognize usage patterns from the operation data and suggest top operations to users 102 of self-evolving connectors 112 to ensure an improved user experience. In some embodiments, instead of users 102 having to browse through hundreds of operations available in an API specification, the pattern recognition tools 116 may provide customized suggestions of top operations to particular users 102 based on their usage patterns. In some embodiments, usage patterns may indicate top connectors and APIs (e.g., most frequently used by users), and these may be further tailored based on profiles of each user.

In some embodiments, pattern recognition tools 116 may identify patterns including top-used operations in the integration platform 110, new API calls, new configurations, and modifications in source code associated with connectors 112 by users 102. Based on the recognized patterns, pattern recognition tools 116 may index new endpoints (e.g., identified by data capture components 114) and generate new connectors 112 or enhance existing connectors 112. In some embodiments, data capture components 114 and/or pattern recognition tools 116 may index the endpoints used by users 102 over a predetermined period of time on the integration platform 110, and update the endpoints based on new values identified during the indexing.

In some embodiments, pattern recognition tools 116 may update connectors 112 by modifying metadata properties in the connector 112, such as an authentication mechanism, changing endpoints, adding additional descriptions and documentation, enriching or overriding the type descriptions, or any other type of relevant functionality of the various connectors 112.

Database 117 may be any of a collection of data storage systems housing information relevant to, used in, and stored by integration platform 110 including information integration flows, collected operation data via data capture components 114, connectors 112, pattern recognition tools 116 (e.g., including machine learning algorithms), and the like. For instance, database 117 may be a database management system or relational database tool. Database 117 may further be a message queue or stream processing platform such as Apache Kafka or Apache Spark or other data storage systems like Apache Hadoop, HDFS, or Amazon S3, to name just some examples. Database 117 may be a data lake, data silo, semi-structured data system (CSV, logs, xml, etc.), unstructured data system, binary data repository, or other suitable repository. Database 117 may store thousands, millions, billions, or trillions (or more) of objects, rows, transactions, records, files, logs, etc. while allowing for the creation, modification, retrieval, archival, and management of this data. In an embodiment, database 117 uses scalable, distributed computing to efficiently catalog, sort, manipulate, and access stored data.

Systems 120, such as system 120A, system 120B, and system 120C, may be an API, data source or other technical resource or system to be included in an integration flow. While three systems 120 are illustrated in FIG. 1 for reference, there may be any number of systems 120 in the environment 100. In some embodiments, systems 120 may represent a plurality of applications or other platforms with which users 102 may want build integrations using integration platform 100. Systems 120 may house data in a number of fashions, such as in a suitable data repository, either in a raw form or following (or at an intermediate step within) the application of a transformational capability. Systems 120 may include data lakes, data silos, message streams, relational databases, semi-structured data (CSV, logs, xml, etc.), unstructured data, binary data (images, audio, video, etc.), or other suitable data types in appropriate repositories, both on-premises and on the cloud. Just for example, systems 120 may provide data or functionalities by connecting to a CRM system, an ERP system, a database, an internet-Of-Things device, a mobile phone, a watch, a JIRA tasklist, a revision control system or other code management tool, and/or a multitude of other sources.

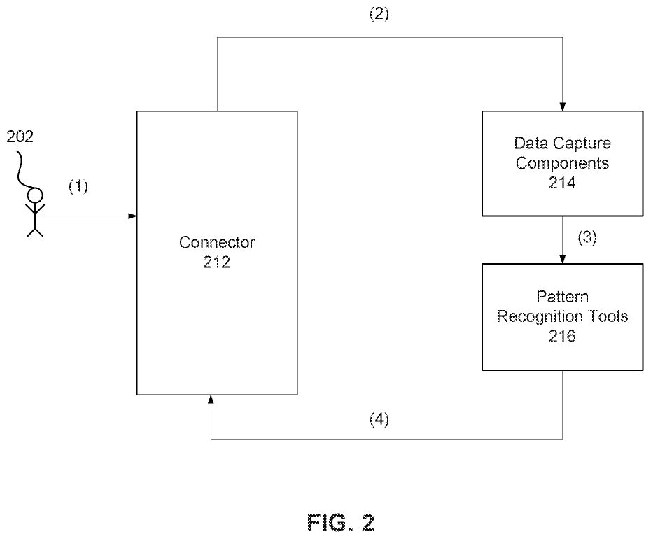

FIG. 2 is a block diagram illustrating a sequence of events for dynamically updating connector modules in an integration platform, according to some embodiments. In particular, FIG. 2 shows a sequence of events or interactions between a user 202, connector 212, data capture components 214, and pattern recognition tools 216 in an integration platform. In some embodiments, user 202, connector 212, data capture components 214, and pattern recognition tools 216 may represent exemplary embodiments of user 104, connector 112, data capture components 114, and pattern recognition tools 116, respectively, shown in FIG. 1.

In a first event, user 201 may engage with connector 212 through a user interface shown on a device (e.g., device 104) of the user 201. In some embodiments, user 201 may engage with connector 212 by configuring the connector to call a new API, including providing configuration information, including a base uniform resource locator (URL), operation information, parameters, authentication information, and the like. In other embodiments, user 201 may engage with connector 212 by adding a trigger to connector 212, using connector 212 to create a new account, receiving an error message while using connector 212, or customizing connector 212 for particular use-case scenarios.

In a second event, operation data from user 201 may be shared with data capture components 214 in an integration platform. In some embodiments, the operation data may represent usage data of the user 201 operating or engaging with connector 212. In some embodiments, data capture components 214 may collect operation data from user 201, in addition to operation data from a plurality of users utilizing the integration platform.

In a third event, data capture components 214 may transmit the collected operation data to pattern recognition tools 216, and pattern recognition tools 216 may identify one or more patterns in the operation data by applying a pattern recognition algorithm to the operation data. In some embodiments, identifying one or more patterns may include identifying top used operations, most frequent error messages received, most used API calls, and/or new configurations or modifications made to the connector 212.

In a fourth event, the pattern recognition tools 216 may update the connector 212 by modifying properties in the connector 212 based on the patterns identified in the third event. In some embodiments, pattern recognition tools 216 (and/or another module or component in the integration platform) may update the connector 212 by indexing new endpoints, auto-generating new connectors, generating resolutions for error messages associated with the connector 212, and the like. In some embodiments, the connector 212 may be updated by changing properties in one or more layers of the connector 212 and may be made available for users to access via the integration platform user interface.

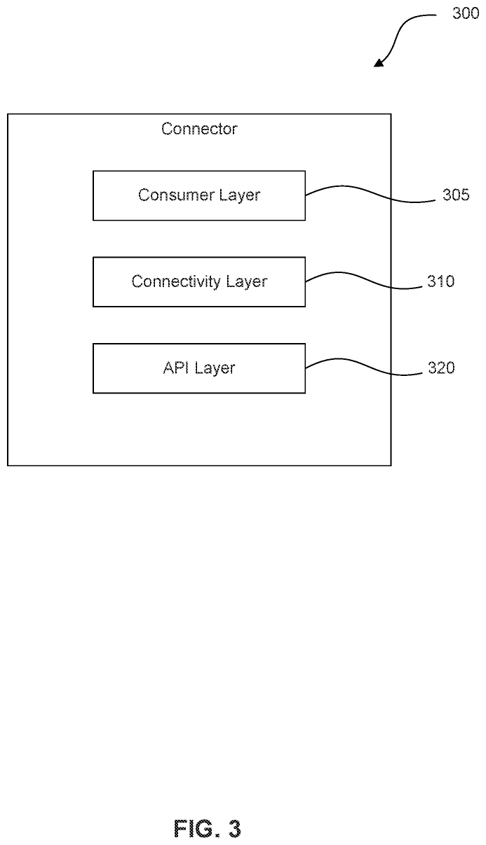

FIG. 3 illustrates a block diagram of a connector 300, according to embodiments of the present disclosure. In some embodiments, connector 300 may represent an exemplary embodiment of connector 112 and connector 212 shown in FIGS. 1 and 2, respectively. In some embodiments, connector 300 may provide a connection between an integration flow and an external resource, such as a database or application via an API. Connector 300 may comprise three layers, including a consumer layer 305, a connectivity layer 310, and an API layer 320.

Consumer layer 305 may comprise data regarding a relevant consumer user experience and credential management. Connectivity layer 310 may comprise data regarding connection handling, security, functional enhancements, pagination, and error handling. API layer 320 may comprise API specifications that define the behavior of the API and how the API links to other APIs. API layer 320 may comprise data regarding request and response documentation, authentication, input and output models, objects and operations, and endpoints. In some embodiments, connector 300 may be updated by the integration platform by modifying properties in one or more of the consumer layer 305, the connectivity layer 310, and/or the API layer 320 based on recognizing patterns in the operation data of users.

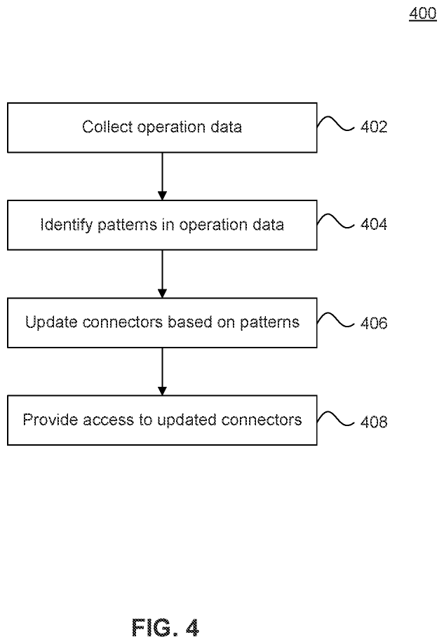

FIG. 4 illustrates a method 400 for updating connector modules in an integration platform using pattern recognition, according to some embodiments. Method 400 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art(s).

In 402, the integration platform 110 may collect operation data regarding a plurality of operations implemented by each user in a plurality of users 102 to build integrations in the integration platform 110, as described above with reference to FIGS. 1-3. In some embodiments, data capture components 114 in integration platform may be used to collect the operation data of the users 102. In some embodiments, the integration platform 110 may connect a plurality of applications with a plurality of users 102, and the plurality of operations may be associated with building integrations using one or more connectors 112. In some embodiments, the integrations may be between at least one external resource, one or more applications, or one or more application programming interfaces (APIs).

In 404, the integration platform 110 may identify one or more patterns in the operation data. In some embodiments, the pattern recognition tools 116 may identify one or more patterns in the operation data by applying a pattern recognition algorithm to the operation data. In some embodiments, the one or more patterns may include data regarding at least one of top used operations in the integration platform 110, new API calls, new configurations, and modifications in source code associated with the one or more connectors 112 by the plurality of users 102. In some embodiments, the pattern recognition tools 116 may train a pattern recognition algorithm using the operation data to predict updates for the one or more connectors 112 in the integration platform 110. In some embodiments, the pattern recognition algorithm may be a neural network or a classifier.

In 406, the integration platform 110 may update the one or more connectors 112 in the integration platform 110 based on the one or more patterns. In some embodiments, the pattern recognition tools 116 may update the connectors 112 by updating one or more metadata properties in the connectors 112. In some embodiments, the metadata properties may comprise at least one of authentication mechanisms, endpoints, operation paths, operation names, operation descriptions, methods, and identifiers.

In 408, the integration platform 110 may provide access to the updated one or more connectors 112 to the plurality of users 102 through the integration platform 110 by deploying the updated one or more connectors 112 on the integration platform 110. In some embodiments, the updated one or more connectors 112 may be stored in database 117 and accessible to users 102 through a user interface provided by integration platform 110.

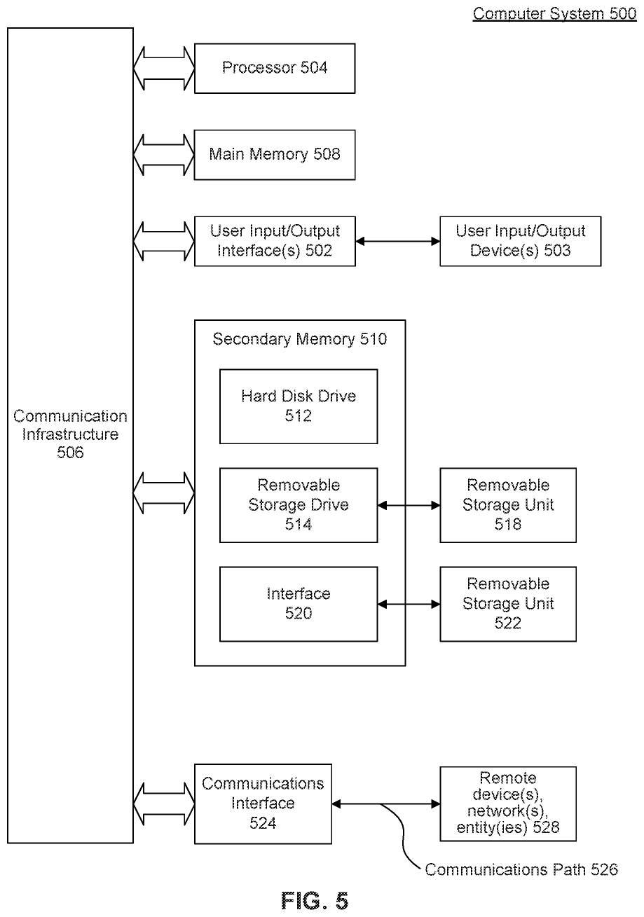

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 508, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method comprising:
collecting, by at least one processor, operation data regarding a plurality of operations implemented by each user in a plurality of users to build integrations in an integration platform, the integration platform connecting a plurality of applications and the plurality of users, and the plurality of operations being associated with building the integrations using one or more connector modules;
identifying, by the at least one processor, one or more patterns in the operation data by applying a pattern recognition algorithm to the operation data, the one or more patterns comprising data regarding at least one of top used operations in the integration platform, new API calls, new configurations, and modifications in source code associated with the one or more connector modules by the plurality of users; and
updating, by the at least one processor, the one or more connector modules in the integration platform based on the one or more patterns.

2. The method of claim 1, further comprising:
deploying the updated one or more connector modules to the plurality of users through the integration platform.

3. The method of claim 1, wherein the integrations provide one or more connections to at least one external resource, one or more applications, or one or more application programming interfaces (APIs).

4. The method of claim 1, further comprising:
training the pattern recognition algorithm with the operation data to predict updates for the one or more connector modules in the integration platform, the pattern recognition algorithm comprising a neural network

5. The method of claim 1, wherein the updating the one or more connector modules further comprises: updating metadata properties in the one or more connector modules.

6. The method of claim 5, wherein the metadata properties comprise endpoints, and the method further comprising: indexing the endpoints used by the plurality of users over a predetermined period of time; and updating the endpoints based on new values identified during the indexing.

7. The method of claim 1, further comprising:
collecting the operation data by monitoring network traffic in the integration platform.

8. A system comprising:
a memory; and
a processor coupled to the memory, wherein the processor is configured to:
collect operation data regarding a plurality of operations implemented by each user in a plurality of users to build integrations in an integration platform, the integration platform connecting a plurality of applications and the plurality of users, and the plurality of operations being associated with building the integrations using one or more connector modules;
identify one or more patterns in the operation data by applying a pattern recognition algorithm to the operation data, the one or more patterns comprising data regarding at least one of top used operations in the integration platform, new API calls, new configurations, and modifications in source code associated with the one or more connector modules by the plurality of users; and
update the one or more connector modules in the integration platform based on the one or more patterns.

9. The system of claim 8, wherein the processor is further configured to:
deploying the updated one or more connector modules to the plurality of users through the integration platform.

10. The system of claim 8, wherein the integrations provide one or more connections to at least one external resource, one or more applications, or one or more application programming interfaces (APIs).

11. The system of claim 8, wherein the processor is further configured to:
train the pattern recognition algorithm with the operation data to predict updates for the one or more connector modules in the integration platform, the pattern recognition algorithm comprising a neural network.

12. The system of claim 8, wherein the processor is further configured to:
collecting the operation data by monitoring network traffic in the integration platform.

13. The system of claim 8, wherein the updating the one or more connector modules further comprises: updating metadata properties in the one or more connector modules.

14. The system of claim 13, wherein the metadata properties comprise endpoints, and wherein the processor is further configured to: index the endpoints used by the plurality of users over a predetermined period of time; and update the endpoints based on new values identified during the indexing.

15. A non-transitory computer-readable device having instructions stored thereon that, when executed by at least one computing device, cause the at least one computing device to perform operations comprising:
collecting operation data regarding a plurality of operations implemented by each user in a plurality of users to build integrations in an integration platform, the integration platform connecting a plurality of applications and the plurality of users, and the plurality of operations being associated with building the integrations using one or more connector modules;
identifying one or more patterns in the operation data by applying a pattern recognition algorithm to the operation data, the one or more patterns comprising data regarding at least one of top used operations in the integration platform, new API calls, new configurations, and modifications in source code associated with the one or more connector modules by the plurality of users; and
updating the one or more connector modules in the integration platform based on the one or more patterns.

16. The non-transitory computer-readable device of claim 15, wherein the integrations provide one or more connections to at least one external resource, one or more applications, or one or more application programming interfaces (APIs).

17. The non-transitory computer-readable device of claim 15, the operations further comprising:
deploying the updated one or more connector modules to the plurality of users through the integration platform.

18. The non-transitory computer-readable device of claim 15, the operations further comprising:
training the pattern recognition algorithm with the operation data to predict updates for the one or more connector modules in the integration platform, the pattern recognition algorithm comprising a neural network.

19. The non-transitory computer-readable device of claim 15, wherein the updating the one or more connector modules further comprises: updating metadata properties in the one or more connector modules.

20. The non-transitory computer-readable device of claim 19, wherein the metadata properties comprise endpoints, and the operations further comprise indexing the endpoints used by the plurality of users over a predetermined period of time; and updating the endpoints based on new values identified during the indexing.
